(19) United States
(12) Patent Application Publication
(10) Pub. No.: US 2010/0157789 A1
(43) Pub. Date: Jun. 24, 2010

(54) RANDOMIZED BACKUP ROUTING

(75) Inventor: Yury BAKSHI, Morganville, NJ (US)

Correspondence Address: AT & T LEGAL DEPARTMENT - GB;ATTN: PATENT DOCKETING, ROOM 2A- 207, ONE AT & T WAY, BEDMINSTER, NJ, 07921, US

(73) Assignee: AT&T Intellectual Property I, L.P., Reno, NV (US)

(21) Appl. No.: 12/342,694

(22) Filed: Dec. 23, 2008

(51) Int. Cl. G08C 15/00

(52) U.S. Cl. 370/216

(57) ABSTRACT

A method of routing a call in a network includes receiving the call at a switching node; selecting a primary route to a destination of the call; determining that the primary route is unavailable; randomly selecting, by the switching node, at least one of a plurality of predetermined backup routes for the primary route; and routing the call to the destination over one of the selected backup routes.

### BACKGROUND

1. Field of the Disclosure

The present disclosure relates to the field of telecommunications. More particularly, the present disclosure relates to a method of selecting a backup route in a telecommunication network.

2. Background Information

In a conventional telecommunications network configuration, a Public Switched Telephone Network (PSTN) may interface with an Internet Protocol (IP) network through Voice over IP (VoIP) gateways. The PSTN will typically select a primary route for a call according to an implemented routing and load distribution methods. For example, for a call from the PSTN to a particular VoIP customer-premises equipment (CPE), a route through a primary gateway (i.e., primary route) may be the same for all calls or differ from call to call (e.g., round robin call distribution between gateways).

### BRIEF DESCRIPTION OF THE DRAWINGS

FIG. 1 shows an exemplary general computer system that includes a set of instructions for routing a call in a network when a network failure occurs;

FIG. 2A illustrates an exemplary network configuration in which embodiments of the present invention can be practiced;

FIG. 2B illustrates exemplary network failures in the network configuration of FIG. 2A;

FIG. 2C illustrates a selection of a backup route in accordance with a conventional routing method;

FIG. 2D illustrates a selection of a backup route in accordance with an exemplary embodiment of the present invention; and

FIG. 3 illustrates a method for routing a call according to an exemplary embodiment of the present invention.

### DETAILED DESCRIPTION

In view of the foregoing, the present disclosure, through one or more of its various aspects, embodiments and/or specific features or sub-components, is thus intended to bring out one or more of the advantages as specifically noted below.

Described herein is a system and method that reduces call loss when a network undergoes multiple simultaneous failures. Those of ordinary skill in the art will understand that network failures may be due to natural disasters (e.g., hurricanes, earthquakes, etc.), due to manmade disasters (e.g., steam pipe explosions, acts of war, etc.), or due to network-related outages (e.g., software failure, power failure, etc.). The proposed system and method may be integrated with many call routing and distribution methods commonly used by network service provider. The proposed system and method does not change a procedure of selecting primary routes already implemented in a network. However, it defines a procedure of randomizing backup route selection, and by doing so, it may make conventional call routing and distribution methods more resilient to multiple network failures.

Described is a method of routing a call in a network, which includes: receiving the call at a switching node; selecting a primary route to a destination of the call; determining that the primary route is unavailable; randomly selecting, by the switching node, at least one of a plurality of predetermined backup routes for the primary route; and routing the call to the destination over one of the selected backup routes.

The plurality of predetermined backup routes for the primary route may be specified in a network element. The plurality of predetermined backup routes for the primary route and a maximum number of allowed backup routes per call may be specified in a routing table in the network element. The primary route may be selected based on a routing or load distribution method. The primary route may be a route to an IP network through a first VoIP gateway, and the plurality of predetermined backup routes may be routes to the IP network through other VoIP gateways.

Determining that the primary route is unavailable may include attempting to route the call via the primary route, and determining that a response from a node on the primary route has not been received within a predetermined period of time. The switching node may be a telephone exchange switch. The destination may be a VoIP CPE.

Also described herein is a system for routing a call in a network, which includes a switching node that receives the call, selects a primary route to a destination of the call, determines when the primary route is unavailable, and randomly selects at least one of a plurality of predetermined backup routes for the primary route, and routes the call to the destination over one of the selected backup routes when the primary route is unavailable.

The system may include a network element which stores the plurality of predetermined backup routes for the primary route, and a maximum number of allowed backup routes per call. The plurality of predetermined backup routes for the primary route may be specified in a routing table in the network element. The switching node may select the primary route based on a routing or load distribution method. The primary route may be a route to an IP network through a first VoIP gateway, and the plurality of predetermined backup routes may be routes to the IP network through other VoIP gateways.

The switching node may determine that the primary route is unavailable by attempting to route the call via the primary route, and determining that a response from a node on the primary route has not been received within a predetermined period of time. The switching node may be a telephone exchange switch. The destination may be a VoIP CPE.

Also described herein is a method of routing a call from a PSTN to an IP network, which includes: receiving the call at a telephone exchange switch; selecting a primary route to the IP network through a first VoIP gateway; determining that the primary route is unavailable; randomly selecting, by the switch, at least one of a plurality of predetermined backup routes to the IP network through other VoIP gateways; and routing the call to the IP network over one of the selected backup routes.

The plurality of predetermined backup routes may be specified in a routing table in a network element. The primary route may be selected based on a routing or load distribution method. Determining that the primary/backup route is unavailable may include attempting to route the call via the primary route, and determining that a response from a node on the primary route has not been received within a predetermined period of time.

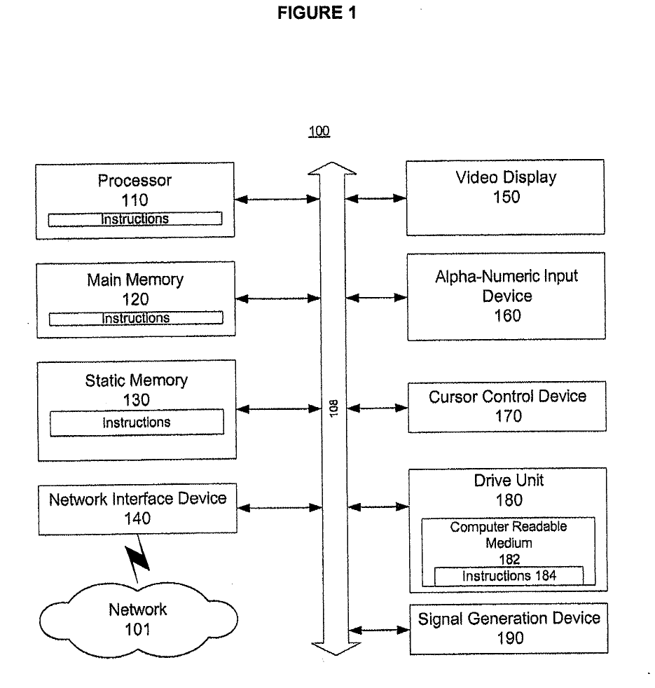

FIG. 1 is an illustrative embodiment of a general computer system, on which a method of routing a call can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

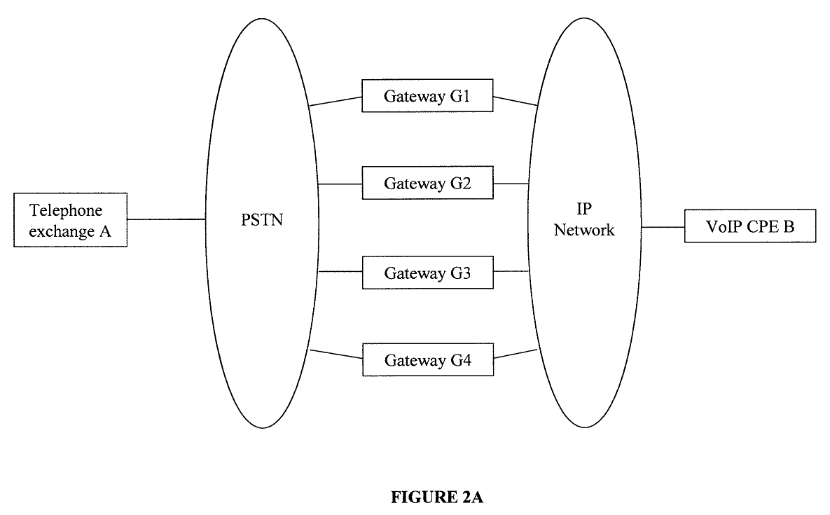

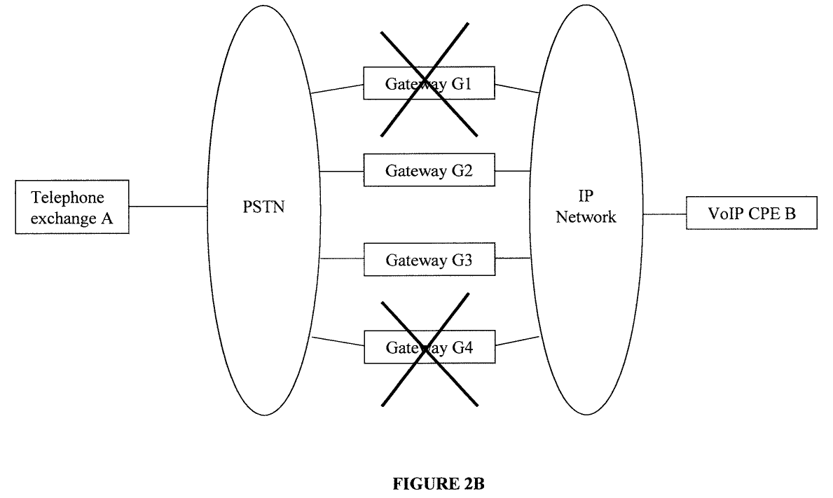

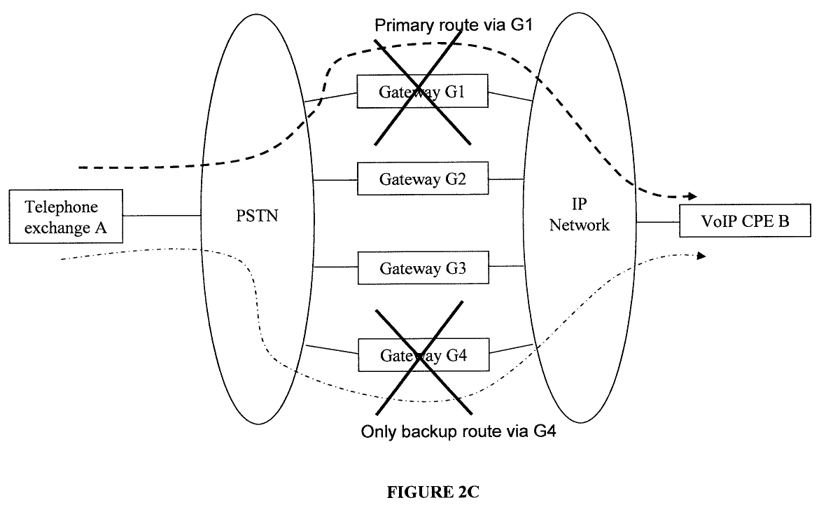

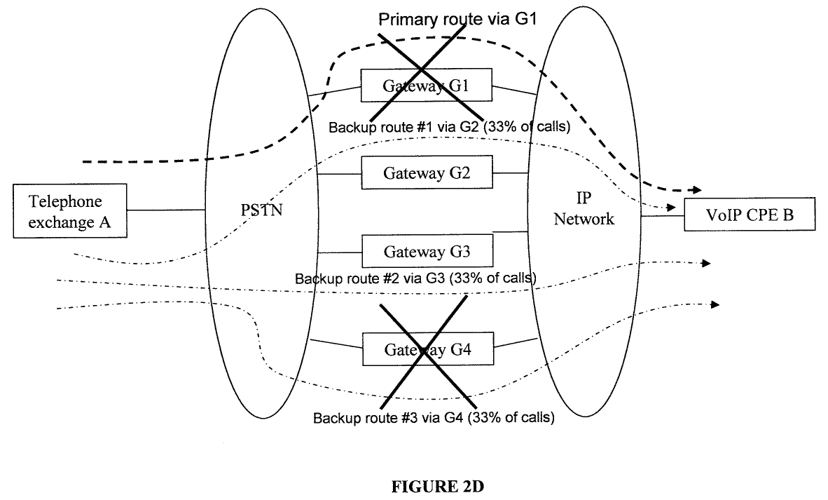

The present invention may be used with a network configuration such as, but not limited to, the configuration shown in FIG. 2A. In this configuration, four VoIP gateways G1-G4 interconnect a PSTN with an IP network. In this exemplary embodiment, the PSTN is provisioned to route calls from a telephone exchange to VoIP CPE through gateways G1-G4. The telephone exchange includes a switching node, such as a switch, that routes telephone calls to their destinations.

When a call is received by the telephone exchange, the switching node determines a primary route to the call destination. For example, the primary route may be determined based on existing routing and load distribution methods employed by the network service provider.

A plurality of predetermined backup routes are designated for each primary route. The predetermined backup routes may be specified, for example, in a routing table in a network element. As an example, routes to the IP network through the gateways G2, G3 and G4 may be specified as being backup routes to a primary route through the gateway G1.

In this embodiment, each time the switching node receives a call to the IP network, when the switching node determines that the primary route to the IP network is down, such as when the gateway G1 has undergone a failure, the switching node randomly selects one of the predetermined backup routes (i.e., a route through one of the gateways G2, G3 or G4), and routes the call through the selected backup route. If the selected backup route is also unavailable, the switching node may randomly select another backup route. The embodiment allows the network service provider to specify a maximum number of backup routes that can be selected. If none of the chosen routes, either primary or backup, are available, the switching node blocks the call. Otherwise, the call is completed over the first available route selected by the embodiment.

The embodiment described above is applicable to switching nodes that are not capable of recognizing a network failure, such as a gateway failure. With such nodes, the switching node may attempt to route a call via a primary route, and then wait for a response from a node on the primary route (such as a gateway) for a predetermined period of time. If the switching node does not receive a response to the call attempt, it then randomly selects one of the predetermined backup routes. In some embodiments, the switching node may make more than one attempt to route the call on the same primary route before selecting a backup route.

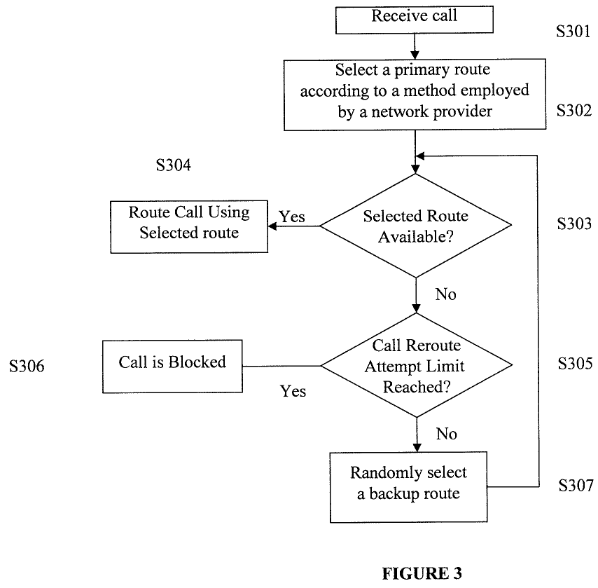

FIG. 3 illustrates a call routing process performed according to an exemplary embodiment of the present invention. In step S301, a telephone call arrives at the telephone exchange. In step S302, the switching node selects a primary route for the call according to any conventional method employed by the network service provider, and in step S303, the switching node determines whether the primary route is available. As noted previously, this may include attempting to route the call via the primary route (possibly multiple times), and determining that a response from a node on the primary route has not been received within a predetermined period of time. If the primary route is available, the call is routed over the primary route in step S304. However, if the switching node determines that the primary route is unavailable at step S303, then the switching node checks if it exhausted allowed number of call reroute attempts at step S303B. If limit is reached the call is blocked at step S303C. If another backup route can be chosen, then the switching node randomly selects one of the specified backup routes at step S305. The switching mode then returns to step S303 where it determines if the selected backup route is operational. As noted previously, this may include attempting to route the call via the selected backup route (maybe multiple times), and determining that a response from a node on the primary route has not been received within a predetermined period of time. If the selected backup route is available, the call is routed over it in step S304. However, if the switching node determines that the chosen backup route is unavailable at step S303, then the switching node checks if it has reached the allowed maximum number of call reroute attempts at step S305. If the maximum number of call reroute attempts has been reached, the call is blocked at step S306. Otherwise, a backup route is randomly selected at step S307 from a plurality of predetermined backup routes, as discussed above.

Accordingly, the present invention enables a network provider to reduce call loss during multiple simultaneous network failures, by randomly selecting a backup route from a set of specified predetermined backup routes.

We will now illustrate how the present invention can be integrated with exemplary call distribution methods, commonly used by network service providers, to reduce call loss during an exemplary multiple failure scenario, shown in FIG. 2B. Let's first assume that all calls between the particular Telephone Exchange A node and VoIP CPE B presented in FIG. 2B are provisioned, in a conventional way, to have two routes: the primary route via Gateway G1 and the secondary route via gateway G4. Hence, the calls will be using primary route via G1 as long as it is available. If the primary route becomes unavailable, the calls will be using the backup route via G4. If both routes become unavailable the call is blocked, as shown in FIG. 2C. Such arrangements, where a primary route is supplemented by the single static backup route, are frequently used by network service providers since they are easy to implement and perform well during single network failures. Let's assume, however, that both G1 and G4 fail, as shown in FIG. 2C. As it was stated earlier, the multiple network failures may be due to natural disasters (e.g., hurricanes, earthquakes, etc.), due to manmade disasters (e.g., steam pipe explosions, acts of war, etc.), or due to network-related outages (e.g., software failure, power failure, etc.). In this case, both primary and backup routes are down and 100% of calls between the considered Telephone Exchange A and VoIP CPE B are being blocked. Hence, this exemplary conventional method of selecting primary/backup routes performs rather poorly during multiple network failures.

With the present invention we can significantly reduce the call blocking between considered Telephone Exchange A and VoIP CPE B. Note that the current invention does not impact how the primary route is selected. It only impacts how backup routes are chosen. We assume that routes through G2, G3 and G4 can be chosen as backup routes. We also assume that only one backup route per call can be selected (i.e., Call Reroute Attempt Limit=1 in step S303 in FIG. 3). Note that allowing a call to be rerouted to the backup routes more than once (i.e., Call Attempt Limit>1) may significantly reduce call blocking. It may, however, increase call setup delay and load network with extra work required to perform multiple call reroutes and should be used with caution. Hence, in this example we will allow only single backup route per call. Under such assumptions only about 33% of calls between Telephone Exchange A and VoIP CPE B will be blocked (compared with 100% of calls being blocked under the exemplary conventional routing). If the primary route is unavailable, the calls will be re-distributed evenly between three available backup routes: via G2, via G3 & via G4, i.e., each backup route will carry ⅓ of original call load between Telephone Exchange A and VoIP CPE B. Calls rerouted via G2 and via G3 (⅔ of calls) will be successfully completed. ⅓ of total call load, rerouted via unavailable G4 will be lost, as illustrated in FIG. 2D.

Note that the current inventions may also be easily integrated with conventional dynamic routing and load distribution methods to reduce call blocking during multiple network failures. For example, it can be shown that when the current invention is integrated with a commonly used Round Robin call distribution method, the call blocking between Telephone Exchange A and VoIP CPE B during simultaneous failures of gateways G1 and G4 may be reduced from 25% down to 17%. Once again, the current invention does not impact initial distribution of calls according to Round Robin. When, however, the primary per-call route is not available, the backup route will be selected randomly among three remaining routes (e.g., if primary via G4 route for a call is unavailable, then the backup for this call will be randomly chosen from three routes: via G1, via G2 and via G3). With a conventional Round Robin method, the back up route is usually the next route in the service list used by round robin method (e.g., if primary via G4 route for a call is unavailable, then the round robin backup route for this call maybe via G1). Hence when integrated with conventional call routing and distribution methods, the randomization of backup routes, as proposed in the current invention, may reduce call blocking during multiple network failures.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of routing a call in a network, comprising:
receiving the call at a switching node;
selecting a primary route to a destination of the call;
determining that the primary route is unavailable;
randomly selecting, by the switching node, at least one of a plurality of predetermined backup routes for the primary route; and
routing the call to the destination over one of the selected backup routes.

2. A method according to claim 1, wherein the plurality of predetermined backup routes for the primary route and a maximum number of allowed backup routes per call are specified in a network element.

3. A method according to claim 2, wherein the plurality of predetermined backup routes for the primary route are specified in a routing table in the network element

4. A method according to claim 1, wherein the primary route is selected based on a routing or load distribution method.

5. A method according to claim 1, wherein the primary route is a route to an Internet Protocol (IP) network through a first Voice over IP (VoIP) gateway, and the plurality of predetermined backup routes are routes to the IP network through other VoIP gateways.

6. A method according to claim 1, wherein determining that the primary route is unavailable comprises attempting to route the call via the primary route, and determining that a response from a node on the primary route has not been received within a predetermined period of time.

7. A method according to claim 1, wherein the switching node is a telephone exchange switch.

8. A method according to claim 1, wherein the destination is Voice over IP customer premise equipment.

9. A system for routing a call in a network, comprising:
a switching node that receives the call, selects a primary route to a destination of the call, determines when the primary route is unavailable, and randomly selects at least one of a plurality of predetermined backup routes for the primary route and routes the call to the destination over one of the selected backup routes when the primary route is unavailable.

10. A system according to claim 9, further comprising a network element which stores the plurality of predetermined backup routes for the primary route, and a maximum number of allowed backup routes per call.

11. A system according to claim 10, wherein the plurality of predetermined backup routes for the primary route are specified in a routing table in the network element.

12. A system according to claim 9, wherein the switching node selects the primary route based on a routing or load distribution method.

13. A system according to claim 9, wherein the primary route is a route to an Internet Protocol (IP) network through a first Voice over IP (VoIP) gateway, and the plurality of predetermined backup routes are routes to the IP network through other VoIP gateways.

14. A system according to claim 9, wherein the switching node determines that the primary route is unavailable by attempting to route the call via the primary route, and determining that a response from a node on the primary route has not been received within a predetermined period of time.

15. A system according to claim 9, wherein the switching node is a telephone exchange switch.

16. A system according to claim 9, wherein the destination is Voice over IP customer premise equipment.

17. A method of routing a call from a Public Switched Telephone Network (PSTN) to an Internet Protocol (IP) network, comprising:
receiving the call at a telephone exchange switch;
selecting a primary route to the IP network through a first Voice over IP (VoIP) gateway;
determining that the primary route is unavailable;
randomly selecting, by the switch, at least one of a plurality of predetermined backup routes to the IP network through other VoIP gateways; and
routing the call to the IP network over one of the selected backup routes.

18. A method according to claim 17, wherein the plurality of predetermined backup routes are specified in a routing table in a network element.

19. A method according to claim 17, wherein the primary route is selected based on a routing or load distribution method.

20. A method according to claim 17, wherein determining that the primary route is unavailable comprises attempting to route the call via the primary route, and determining that a response from a node on the primary route has not been received within a predetermined period of time.
